(19) United States
(12) Patent Application Publication
(10) Pub. No.: US 2016/0150329 A1
(43) Pub. Date: May 26, 2016

(54) HEARING DEVICE FOR A HEARING SYSTEM

(71) Applicant: GN ReSound A/S, Ballerup (DK)

(72) Inventor: Jonas Raun HANSEN, Roskilde (DK)

(73) Assignee: GN RESOUND A/S, Ballerup (DK)

(21) Appl. No.: 14/549,470

(22) Filed: Nov. 20, 2014

(30) Foreign Application Priority Data
Nov. 20, 2014 (DK) PA 2014 70721
Nov. 20, 2014 (EP) 14194104.7

(51) Int. Cl. H04R 25/00

(52) U.S. Cl. CPC H04R 25/407

(57) ABSTRACT

A hearing device includes: a directional microphone assembly for provision of an electrical audio signal, and a processing unit connected to the microphone assembly, wherein the microphone assembly comprises a body and a first microphone, the body comprising a first sound path and a plurality of inlets, the first sound path having one or more bends, the plurality of inlets including a first inlet in fluid communication with the first sound path, and a second inlet, wherein the body has a first outlet in fluid communication with the first sound path, wherein the first microphone in a first directional mode is in fluid communication with the first outlet, and wherein a first distance between the first inlet and the first outlet along the first sound path, and a second distance between the second inlet and the first outlet along the first sound path, are different.

### RELATED APPLICATION DATA

This application claims priority to and the benefit of Danish Patent Application No. PA 2014 70721, filed on Nov. 20, 2014, pending, and European Patent Application No. 14194104.7, filed on Nov. 20, 2014, pending. The entire disclosures of both of the above applications are expressly incorporated by reference herein.

### FIELD

The present disclosure relates to a hearing device for a hearing system, and in particular to a hearing device with a directional microphone assembly.

### BACKGROUND

Hearing aid users may benefit from using various hearing devices or accessory devices together with their hearing aid. If the hearing aid user for example wishes to clearly hear a person speaking at a conference or a spouse in a restaurant, a microphone may be placed at the person/spouse speaking and the hearing aid user will receive the improved sound in his/her hearing aid.

A directional microphone system or assembly or array typically comprises many microphones, and the directionality is obtained by means of the plurality of microphones providing delay-and-add, delay-and-subtract and/or delay-and-sum functionality or processing or a mix of these.

A shotgun microphone comprises one microphone and holes or inlets providing directionality.

A pressure-gradient microphone is a delay and subtract beamformer providing a cardioid polar pattern. A pressure gradient microphone comprises at least two sound paths due to membranes or diaphragms arranged at the outlet where the microphone is arranged.

### SUMMARY

There is a need for an improved hearing device with a directional microphone assembly.

Disclosed is a hearing device, the hearing device comprising a directional microphone assembly for provision of an electrical audio signal; and a processing unit connected to the microphone assembly. The microphone assembly comprises a body and a first microphone, the body comprising a sound path structure with a first sound path inside the body, the body having a plurality of inlets in fluid communication with the sound path structure. The plurality of inlets includes a first inlet in fluid communication with the first sound path, and a second inlet. The body has a first outlet in fluid communication with the first sound path, wherein the first microphone in a first directional mode or at least in a first directional mode is in fluid communication with the first outlet, the first sound path optionally having one or more bends, and wherein a first distance between the first inlet and the first outlet along the sound path structure and a second distance between the second inlet and the first outlet along the sound path structure are different. Thus there is a different path length for the direct sound path and the sound paths from the other inlets in the body, relative to the sound path outside the body.

The hearing device as disclosed provides a directional microphone assembly using a first microphone, inlets and an outlet, where directionality is obtained by means of the structural and mechanical means, i.e. a single microphone may be sufficient to obtain directionality.

It may be advantageous to have more than one inlet along the same sound path, such as along the first sound path, since increasing or decreasing the number of inlets along the same sound path will attenuate certain frequencies at certain directions, thereby creating the directional behaviour at the outlet to the microphone, whereby the hearing device can be used as a directional microphone assembly.

It is an advantage that a small hearing device or a hearing aid with reduced maximum extension is provided. Thereby a compact hearing device can be provided.

The performance of the microphone assembly and thus of the hearing device depends e.g. on the size and length of the sound path structure and inlet size, such as the cross sectional area of the inlets. The dimensions of these features determines e.g. which frequencies and directions are attenuated and amplified determining the delay and sum functionality of the microphone assembly.

A hearing device includes: a directional microphone assembly for provision of an electrical audio signal, and a processing unit connected to the microphone assembly, wherein the microphone assembly comprises a body and a first microphone, the body comprising a first sound path and a plurality of inlets, the first sound path having one or more bends, the plurality of inlets including a first inlet in fluid communication with the first sound path, and a second inlet, wherein the body has a first outlet in fluid communication with the first sound path, wherein the first microphone in a first directional mode is in fluid communication with the first outlet, and wherein a first distance between the first inlet and the first outlet along the first sound path, and a second distance between the second inlet and the first outlet along the first sound path, are different.

Optionally, the first inlet and the second inlet are arranged along the first sound path, and the second inlet is in fluid communication with the first sound path, and wherein the first inlet and the second inlet are arranged between a first primary end of the first sound path and the first outlet.

Optionally, a primary inter-inlet distance between the first inlet and the second inlet is anywhere from 2 mm to 40 mm.

Optionally, a secondary inter-inlet distance between the first inlet and the second inlet is anywhere from 1 mm to 20 mm.

Optionally, a difference between the primary inter-inlet distance and the secondary inter-inlet distance between the first inlet and the second inlet determines at least part of a directionality of the hearing device.

Optionally, the plurality of inlets comprises a third inlet in fluid communication with the first sound path.

Optionally, the body comprises a plurality of parts including a first part and a second part.

Optionally, the first part and the second part of the body are movable relative to each other, and are configured to have at least a first relative position in a first directional mode, and a second relative postion in a second directional mode .

Optionally, a length of the first sound path is anywhere from 3 cm to 15 cm.

Optionally, the first inlet has a first cross-sectional area that is anywhere from 0.5 mm2 to 5 mm2.

Optionally, the one or more bends includes a first bend with an angle that is anywhere from 45° to 225°.

Optionally, the first bend is located between the first inlet and the second inlet.

Optionally, the body has a second outlet in fluid communication with the first sound path, and wherein the first microphone in a second directional mode is in fluid communication with the second outlet.

Optionally, the microphone assembly comprises a second microphone.

Optionally, the body has an inner surface and an outer surface, the inner surface defining the first sound path, and wherein the plurality of inlets is in the outer surface.

Other and further aspects and features will be evident from reading the following detailed description of the embodiments.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary hearing device,

FIG. 2 schematically illustrates an exemplary directional microphone assembly,

FIG. 3 is a first surface view of an exemplary body,

FIG. 4 is a second surface view of an exemplary body,

FIG. 5 schematically illustrates an exemplary body,

FIG. 6 schematically illustrates an exemplary body,

FIG. 7 schematically illustrates an exemplary body, and

FIG. 8 schematically illustrates an exemplary body.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

The hearing device comprises a directional microphone assembly, e.g. for provision of an electrical audio signal.

The hearing device comprises a processing unit connected to the microphone assembly, e.g. for receiving the electrical audio signal.

The hearing device may be a hearing aid, a headset, and/or an accessory device for a hearing aid or headset. The hearing device may be in the form of a speakerphone, a conference microphone, a spouse microphone etc.

The microphone assembly comprises a body and a first microphone. The body comprises a sound path structure with a first sound path inside the body. The sound path structure may be a tube manufactured as a one piece component in for example plastic. The sound path structure may be formed as one or more canals, channels, passages, grooves etc in a body. A sound path may have a squared, oval, circular, and/or otherwise rounded cross-section along the sound path. The first sound path may have a cross sectional area in the range from 0.5 mm² to 5 mm², such as 2 mm².

The body has a plurality of inlets in fluid communication with the sound path structure. The body may have an inner surface and an outer surface. The inner surface may form the sound path structure. The plurality of inlets may be in the outer surface.

The number of inlets may be in the range from three to thirty, such as in the range from six to eight, such as seven inlets. The plurality of inlets includes a first inlet in fluid communication with the first sound path, and a second inlet. The second inlet may be arranged along the first sound path and be in fluid communication with the first sound path. An inlet transfers sound or sound waves from the outside or surroundings into the sound path structure or parts thereof. An element, such as a mesh, membrane, screen or foam element, may cover an inlet, e.g. to reduce the risk of dirt being deposited in the sound path structure. The inlets may be arranged along a straight line seen on the outer surface of the body. The second inlet may be arranged between the first inlet and the first outlet.

An inlet, such as the first inlet and/or the second inlet, may have a first cross-sectional area in the range from 0.5 mm² to 5 mm², such as 2 mm².

The sound path structure may comprise a second sound path, and the second inlet may be arranged along the second sound path and be in fluid communication with the second sound path. Accordingly, the first inlet and the second inlet may be arranged along different sound paths of the sound path structure. The second sound path may have a cross sectional area in the range from 0.5 mm² to 5 mm², such as 2 mm².

The body has a first outlet in fluid communication with the first sound path. An outlet may be configured to transfer sound or sound waves travelling in the sound path structure to the surroundings, such as towards a membrane of a microphone arranged close to or at the outlet.

The first microphone may, at least in a first directional mode, be in fluid communication with the first outlet. The first microphone may, at least in the first directional mode, be sealed to the first outlet such that no sound leaks occur.

The first sound path has one or more bends inside the body, such as a first bend and/or a second bend. The bends of the sound path may be termed folds, folded structure, turns, turnings etc.

A first distance between the first inlet and the first outlet along the sound path structure and a second distance between the second inlet and the first or second outlet along the sound path structure are different. For example, the first distance may be in the range from 3 cm to 15 cm. The second distance may be in the range from 3 cm to 15 cm.

The distance between the inlets, i.e. the inter-inlet distance, may in case of more than two inlets be different or be identical, uniform or equal. Changing the inter-inlet distance between the sound inlets will change the beamforming and thereby the directionality of the microphone assembly.

The primary or internal inter-inlet distance between inlets is measured as the shortest distance along the sound path structure. The secondary or external inter-inlet distance is measured as the shortest distance between respective inlets along an outer surface of the body. The secondary or external inter-inlet distance may be termed the absolute shortest distance.

The first inlet and/or the second inlet may be arranged along the first sound path. The second inlet may be in fluid communication with the first sound path.

The first inlet and/or the second inlet may be arranged between a first primary end of the first sound path and the first outlet.

One or more inlets may, e.g. in one or more directional modes, be blocked or covered for obtaining a different directionality of the microphone assembly. Alternatively and/or additionally the position of the inlets may be configured for obtaining a different directionality in different directional modes.

The primary inter-inlet distance D_{1,2} between the first inlet and the second inlet may be in the range from 2 mm to 40 mm, such as in the range from 10 mm to 30 mm, such as 20 mm.

The secondary inter-inlet distance D′_{1,2} between the first inlet and the second inlet may be in the range from 1 mm to 20 mm, such as 10 mm.

The difference between D_{1,2} and D′_{1,2} may influence and/or determine at least part of the directionality of the hearing device. For example, the difference Δ_{1,2} between D_{1,2} and D′_{1,2} may be in the range from 1 mm to 20 mm, such as 5 mm, 10 mm or 15 mm.

The plurality of inlets may comprise a third inlet in fluid communication with the sound path structure. The third inlet may be arranged along the first sound path and may be in fluid communication with the first sound path. The third inlet may be arranged between the second inlet and the first outlet.

The plurality of inlets may comprise a fourth inlet in fluid communication with the sound path structure. The fourth inlet may be arranged along the first sound path and may be in fluid communication with the first sound path. The fourth inlet may be arranged between the third inlet and the first outlet.

The primary inter-inlet distance D_{2,3} between the second inlet and the third inlet may be in the range from 2 mm to 40 mm, such as in the range from 10 mm to 30 mm, such as 20 mm.

The secondary inter-inlet distance D′_{2,3} between the second inlet and the third inlet along an outer surface of the body may be in the range from 1 mm to 20 mm, such as 10 mm.

The difference between D_{2,3} and D′_{2,3} may influence and/or determine at least part of the directionality of the hearing device. For example, the difference Δ_{2,3} between D_{2,3} and D′_{2,3} may be in the range from 1 mm to 20 mm, such as 5 mm, 10 mm or 15 mm.

The body may comprise a plurality of parts including a first part and/or a second part. The first part and the second part may be assembled by welding, using e.g. ultrasound, by gluing, by click lock, by press fitting etc. A multi-part body facilitates a more complex sound path structure. Further, a multi-part body may facilitate a hearing device with user-configurable directional modes.

The first part of the body may comprise a primary sound path structure with a first primary sound path inside the body. The first part of the body may have a plurality of primary inlets in fluid communication with the primary sound path structure.

The plurality of primary inlets may include a first primary inlet in fluid communication with the first primary sound path, and a second primary inlet. The first part of the body may have one or more primary outlets including a first primary outlet in fluid communication with the first primary sound path and/or a second primary outlet in fluid communication with the first primary sound path. The first primary sound path may have one or more primary bends.

The second part of the body may comprise a secondary sound path structure with a first secondary sound path inside the body. The second part of the body may have one or more secondary inlets in fluid communication with the secondary sound path structure. The one or more secondary inlets may include a first secondary inlet in fluid communication with the first secondary sound path, and optionally a second secondary inlet. The second part of the body may have a first secondary outlet in fluid communication with the first secondary sound path. The first microphone may at least in a first directional mode be in fluid communication with the first secondary outlet. The first secondary sound path may have one or more secondary bends.

One or more of the primary outlet(s) may be in fluid communication with one or more secondary inlets, respectively. Thus, the primary inlets of the first part may form the inlets of the body and the secondary outlet(s) of the second part may form the outlet(s) of the body.

In a first directional mode, the first primary outlet may be in fluid communication with a first secondary inlet. In a first directional mode, a second primary outlet may be in fluid communication with a second secondary inlet or blocked, e.g. by the second part.

It may be advantageous to be able to configure and use the hearing device in different directional modes. Accordingly, the first part and the second part of the body may be movable relative to each other, e.g. along an axis and/or by rotation about an axis. Thus the first part and the second part may be configured to have at least a first relative position in a first directional mode and a second relative postion in a second directional mode. Thus the first primary outlet may, in a second directional mode, be in fluid communication with a different secondary inlet than in the first directional mode or blocked. For example, the first primary outlet may in the second directional mode be in fluid communication with the second secondary inlet or a third secondary inlet of the second part. Thus, the body, when configured to the first directional mode (first relative position between first part and second part), may have a sound path structure different from the sound path structure of the body in the second directional mode (second relative position between first part and second part). In different modes, the first sound path may have different length and/or shape.

In a second directional mode, a second primary outlet may be in fluid communication with a third secondary inlet or blocked.

In an exemplary directional mode, such as the second directional mode or a third directional mode, the body may be configured to have only one inlet in fluid communication with the first outlet.

The first part of the body may constitute, comprise or form a lid relative to or to the second part of the body. The body may comprise one or more intermediate parts arranged between the first part and the second part.

The first part may have one or more recesses including a first recess in an outer surface thereof. The second part may have one or more recesses including a second recess in an outer surface thereof. When assembled or in a first or second directional mode, the first recess and the second recess are aligned to form a part of the first sound path. When assembled or in a first or second directional mode, the first recess and a part of the outer surface of the second part may form a part of the first sound path. When assembled or in a first or second directional mode, the second recess and a part of the outer surface of the first part may form a part of the first sound path.

The length of the first sound path may be in the range from 3 cm to 15 cm, such as 9 cm. The length of the second sound path may be in the range from 3 cm to 15 cm, such as 9 cm. The one or more bends in the first sound path may include a first bend. The first bend may be in the range from 45° to 225°, such as 90°, 135° or 180°.

The first bend may be arranged between the first inlet and the second inlet.

The one or more bends in the first sound path may include a second bend. The second bend may be in the range from 45° to 225°, such as 90°, 135° or 180°.

The first sound path may be curved. It may be an advantage that the first sound path is curved, since this allows for a compact and small body and/or hearing device compared to a body with a straight sound path.

The body may have a second outlet. The second outlet may be in fluid communication with the first sound path. The second outlet may be in fluid communication with the second sound path. The first microphone, in a second directional mode, may be in fluid communication with the second outlet. The first microphone may, at least in the second directional mode, be sealed to the second outlet such that no sound leaks occur.

The microphone assembly may comprise a second microphone. The second microphone may be in fluid communication with the second outlet. The second microphone may be sealed to the second outlet such that no sound leaks occur. The hearing device may further comprise a communication module connected to the processing unit and configured to communicate with the hearing system.

The hearing device may be or may comprise a hearing aid and/or a headset, and the hearing device may be configured to communicate with the hearing aid and/or headset.

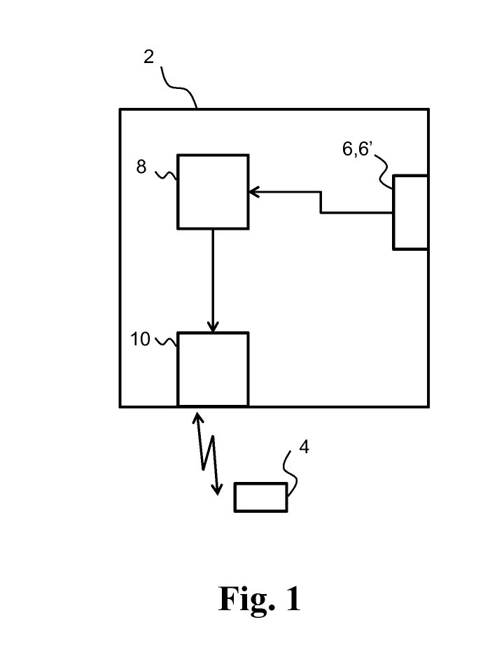

FIG. 1 schematically illustrates an exemplary hearing device 2 for a hearing system 4. The hearing device 2 comprises a directional microphone assembly 6, 6′ for provision of an electrical audio signal. The hearing device 2 further comprises a processing unit 8 connected to the microphone assembly 6. The hearing device 2 optionally comprises a communication module 10 connected to the processing unit 8 and configured to communicate with the hearing system 4. The hearing system 4 may comprise a hearing aid or a headset. The hearing device 2 and the hearing system 4 communicates wirelessly over wireless connection, e.g. according to a specific hearing aid communication standard, Bluetooth, WiFi, 3G, 4G, by induction, FM and/or the like. Alternatively and/or additionally the hearing device 2 and the hearing system 4 are wired.

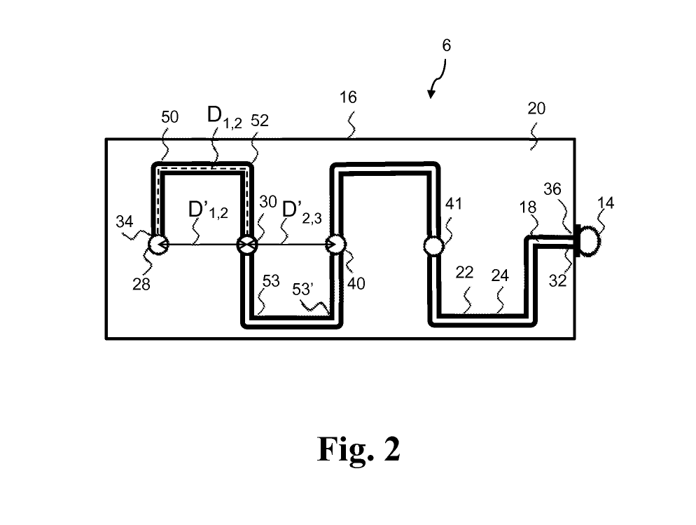

FIG. 2 schematically illustrates an exemplary directional microphone assembly 6. The microphone assembly 6 comprises a first microphone 14 and a body 16, the body 16 having an inner surface 18 and an outer surface 20. The inner surface 18 forms a sound path structure 22 with a first sound path 24 inside the body 16. For illustrative purposes, the course of the sound path structure 22 inside the body is also shown. The body 16 has a plurality of inlets in the outer surface 20 and in fluid communication with the sound path structure 22. The plurality of inlets includes at least a first inlet 28 and a second inlet 30 in fluid communication with the first sound path 24.

Further, the body 16 has a first outlet 32 in the outer surface and in fluid communication with the first sound path 24. The first sound path 24 has a first primary end 34 and a first secondary end 36 with one or more bends including a first bend 50 and a second bend 52, from the first primary end 34 to the first secondary end 36. The first inlet 28 and the second inlet 30 are arranged along the first sound path 24 and in fluid communication with the first sound path 24. The first inlet 28 and the second inlet 30 are arranged between the first primary end 34 of the first sound path 24 and the first outlet 32. The second inlet 30 is arranged between the first inlet 28 and the first outlet 32. Further, the plurality of inlets includes a third inlet 40 and a fourth inlet 41 in fluid communication with the first sound path 24. The inlets 28, 30, 40 and 41 are arranged along a straight line.

The first bend 50 and the second bend 52 of the first sound path are arranged between the first inlet 28 and the second inlet 30, in effect providing a difference Δ_{1,2} between the primary inter-inlet distance D_{1,2} shown with the dotted line and the secondary inter-inlet distance D′_{1,2} between the first inlet and the second inlet.

Further, the first sound path 22 has a third bend 53 and a fourth bend 53′ optionally arranged between the second inlet 30 and the third inlet 40.

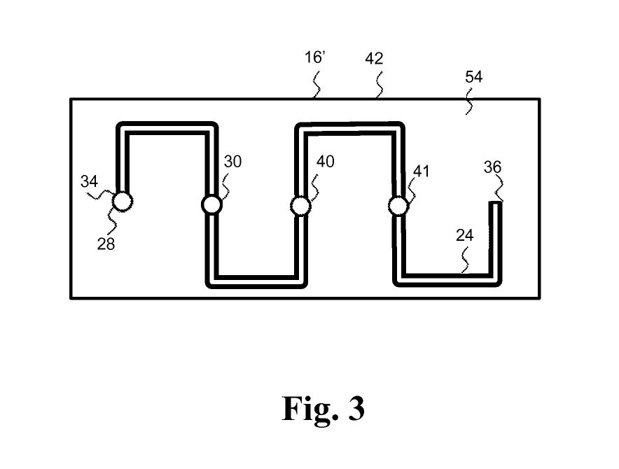

FIG. 3 schematically illustrates an exemplary first surface view of an exemplary body 16′ of a hearing device, which may be a first part 42 of a microphone assembly. For illustrative purposes, the course of the first sound path 24 inside the body is also shown. The first surface 54 of the body 16′ has at least two, such as four inlets 28, 30, 40, 41 in fluid communication with the first sound path 24 and arranged between the first primary end 34 and the first secondary end 36 of the sound path 24.

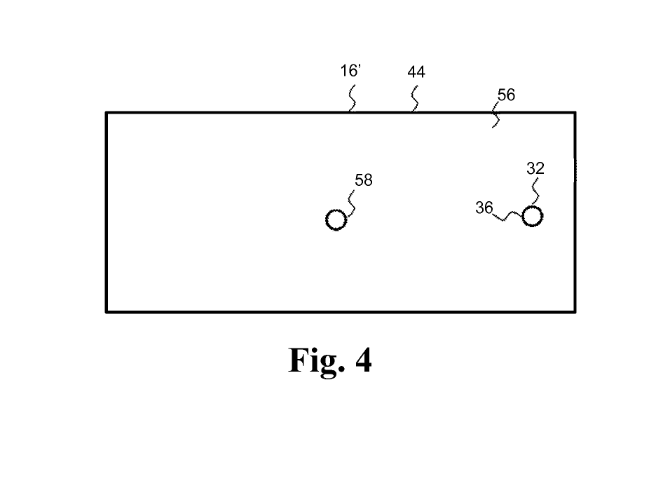

FIG. 4 schematically illustrates an exemplary second surface view of the body 16′ in FIG. 3, which may be a second part 44 of the microphone assembly. The second surface 56 of the body 16′ has one or more outlets, including a first outlet 32 and a second outlet 58 in fluid communication with the first sound path 24 and arranged between the first primary end and the first secondary end 36 of the sound path 24. The second outlet 58 may be omitted. The first microphone may be arranged at the first outlet 32 in a first directional mode and/or at the second outlet 58 in a second directional mode, i.e. the second outlet 58 may correspond to a second position of the first microphone. The first microphone may be moved relative to the body 16′ in order to cover either the first outlet 32 or the second outlet 58. Alternatively and/or additionally, the body 16′ and/or the second part 44 of the microphone assembly and/or a part of the second part 44 may be moved relative to the first microphone whereby the first outlet 32 and/or the second outlet 58 is/are moved relative to the first microphone, such that the first outlet 32 or the second outlet 58 is open for the first microphone. At the same time, the other outlet may be blocked or covered. Hereby different directional modes with different directionality and/or beamforming can be obtained by the hearing device.

FIG. 5 shematically illustrates an exemplary body 16″ of a hearing device with a sound path structure comprising a first sound path 24′ and a second sound path 62. For illustrative purposes, the course of the sound path structure inside the body is shown. The body 16″ has a plurality of inlets in fluid communication with the sound path structure. The plurality of inlets includes at least a first inlet 28 in fluid communication with the first sound path 24′, and a second inlet 30 in fluid communication with the second sound path 62. Further, the body 16 has a first outlet 32 in the outer surface and in fluid communication with the first sound path 24 and a second outlet 58 in the outer surface and in fluid communication with the second sound path 62. The first distance between the first inlet and the first outlet is different from the second distance between the second inlet and the second outlet.

Alternatively and/or additionally, the first sound path 24′ and the second sound path 62 may share a common sound path part along a part of the first and second sound paths, for example in the part of the sound paths towards the first microphone, whereby there may be only one outlet, the first outlet 32, which the first sound path 24 and second sound path 62 share.

Thus there may be fluid communication between the two sound paths at the outlet at the microphone, whereby the sound signals may be mixed since there may be a shared volume in front of the microphone.

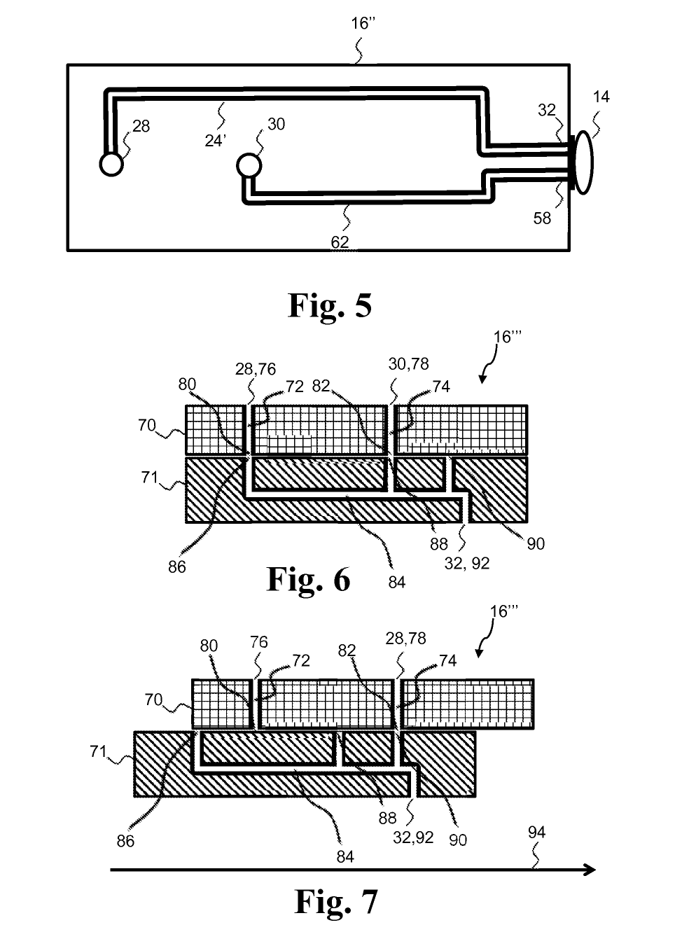

FIG. 6 is a cross-sectional side view of an exemplary body 16″. The body comprises a first part 70 and a second part 71. The first part 70 has a primary sound path structure comprising a first primary sound path 72 inside the body. Further, the primary sound path structure optionally comprises a first secondary sound path 74. The first part 70 has a first primary inlet 76 in fluid communication with the first primary sound path 72, and a second primary inlet 78 in fluid communication with the first secondary sound path 74. The first part 70 has a first primary outlet 80 in fluid communication with the first primary sound path 80 and a second primary outlet 82 in fluid communication with the first secondary sound path 74. Alternatively or in combination, the second primary outlet 82 may be in fluid communication with the first primary sound path 72 (not shown).

The second part 71 comprises a secondary sound path structure with a first secondary sound path 84 inside the body. The second part of the body has a first secondary inlet 86, a second secondary inlet 88, and a third secondary inlet 90, the inlets 86, 88, 90 being in fluid communication with the first secondary sound path 84. Further, the second part 71 has a first secondary outlet 92 in fluid communication with the first secondary sound path 84. The first microphone may at least in a first directional mode be in fluid communication with the first secondary outlet. The first secondary sound path may have one or more secondary bends.

In a first directional mode, e.g. as illustrated in FIG. 6 where the first part 70 and the second part 71 has a first relative position, the first primary outlet 80 is aligned with and in fluid communication with the first secondary inlet 86, and the second primary outlet 82 is aligned with and in fluid communication with the second secondary inlet 88. In FIG. 6, the primary inlets 76, 78 of the first part 70 form the inlets of the body and the first secondary outlet 92 of the second part forms the outlet of the body. In the illustrated first directional mode, the third secondary inlet 90 is blocked by the first part 70. The first part 70 and the second part 71 may be fixed in relation to each other or may be movable relative to each other, e.g. along an axis and/or by rotation about an axis.

FIG. 7 a cross-sectional side view of the exemplary body 16″′ in a second directional mode, i.e. where the first part 70 and the second part 71 have a second relative position and are movable relative to each other, here as illustrated along an axis 94. In the second directional mode, second primary outlet 82 is aligned with and in fluid communication with the third secondary inlet 90. In FIG. 7, the primary inlet 78 of the first part 70 forms the first inlet of the body and the first secondary outlet 92 of the second part forms the outlet of the body. In the illustrated second directional mode, the first secondary inlet 86 and the second secondary inlet 88 are blocked by the first part 70. The first part 70 and the second part 71 may be fixed in relation to each other or may be movable relative to each other, e.g. along an axis and/or by rotation about an axis.

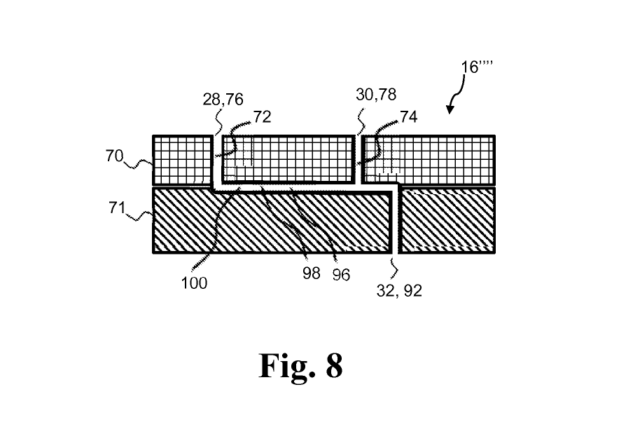

FIG. 8 is a cross-sectional side view of an exemplary body 16″″. The body comprises a first part 70 and a second part 71 and a part 96 of the first sound path 24 is formed by a first recess 98 in the outer surface of the first part 70 and a second recess 100 in the outer surface of the second part 71. When assembled or in a first or second directional mode, the first recess and the second recess are aligned to form a part of the first sound path.

It should be noted that the terms “first”, “second”, “third”, etc., as used in this specification, are used to identify respective items, and so they do not necessarily convey or define order. Also, these terms may be interchanged. For example, in some cases, the microphone assembly may be considered as having first inlet 28, second inlet 30, and third inlet 40. In other cases, the microphone assembly may be considered as having first inlet 30 and second inlet 40.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications and equivalents.

### LIST OF REFERENCES

2 hearing device
4 hearing system
6, 6′, 6″ directional microphone assembly
8 processing unit
10 communication module
12 microphone
14 first microphone
16, 16′, 16″, 16″′, 16″″ body
18 inner surface
20 outer surface
22 sound path structure
24, 24′ first sound path
26 inlets
28 first inlet
30 second inlet
32 first outlet
34 first primary end
36 first secondary end
40 third inlet
41 fourth inlet
42 first part of microphone assembly
44 second part of microphone assembly
50 first bend
52 second bend
53 third bend
53′ fourth bend
54 first surface of body
56 second surface of body
58 second outlet
62 second sound path
70 first part
71 second part
72 first primary sound path
74 first secondary sound path
76 first primary inlet
78 second primary inlet
80 first primary outlet
82 second primary outlet
84 first secondary sound path
86 first secondary inlet
88 second secondary inlet
90 third secondary inlet
94 axis
96 part of first sound path
98 first recess
100 second recess

1. A hearing device comprising:
a directional microphone assembly for provision of an electrical audio signal; and
a processing unit connected to the microphone assembly;
wherein the microphone assembly comprises a body and a first microphone, the body comprising a first sound path and a plurality of inlets, the first sound path having one or more bends, the plurality of inlets including a first inlet in fluid communication with the first sound path, and a second inlet;
wherein the body has a first outlet in fluid communication with the first sound path;
wherein the first microphone in a first directional mode is in fluid communication with the first outlet; and
wherein a first distance between the first inlet and the first outlet along the first sound path, and a second distance between the second inlet and the first outlet along the first sound path, are different.

2. The hearing device according to claim 1, wherein the first inlet and the second inlet are arranged along the first sound path, and the second inlet is in fluid communication with the first sound path, and wherein the first inlet and the second inlet are arranged between a first primary end of the first sound path and the first outlet.

3. The hearing device according to claim 1, wherein a primary inter-inlet distance between the first inlet and the second inlet is anywhere from 2 mm to 40 mm.

4. The hearing device according to claim 3, wherein a secondary inter-inlet distance between the first inlet and the second inlet is anywhere from 1 mm to 20 mm.

5. The hearing device according to claim 4, wherein a difference between the primary inter-inlet distance and the secondary inter-inlet distance between the first inlet and the second inlet determines at least part of a directionality of the hearing device.

6. The hearing device according to claim 1, wherein the plurality of inlets comprises a third inlet in fluid communication with the first sound path.

7. The hearing device according to claim 1, wherein the body comprises a plurality of parts including a first part and a second part.

8. The hearing device according to claim 7, wherein the first part and the second part of the body are movable relative to each other, and are configured to have at least a first relative position in a first directional mode, and a second relative postion in a second directional mode .

9. The hearing device according to claim 1, wherein a length of the first sound path is anywhere from 3 cm to 15 cm.

10. The hearing device according to claim 1, wherein the first inlet has a first cross-sectional area that is anywhere from 0.5 mm² to 5 mm².

11. The hearing device according to claim 1, wherein the one or more bends includes a first bend with an angle that is anywhere from 45° to 225°.

12. The hearing device according to claim 11, wherein the first bend is located between the first inlet and the second inlet.

13. The hearing device according to claim 1, wherein the body has a second outlet in fluid communication with the first sound path, and wherein the first microphone in a second directional mode is in fluid communication with the second outlet.

14. The hearing device according to claim 1, wherein the microphone assembly comprises a second microphone.

15. The hearing device according to claim 1, wherein the body has an inner surface and an outer surface, the inner surface defining the first sound path, and wherein the plurality of inlets is in the outer surface.
